(19) United States
(12) Patent Application Publication
(10) Pub. No.: US 2017/0240455 A1
(43) Pub. Date: Aug. 24, 2017

(54) SYSTEM AND METHOD FOR FORMING A QUARTZ GLASS OPTICAL COMPONENT

(71) Applicant: Heraeus Tenevo LLC, Buford, GA (US)

(72) Inventors: Kai CHANG, Decatur, GA (US); Georges Levon FATTAL, Suwanee, GA (US); Qiulin MA, Duluth, GA (US)

(21) Appl. No.: 15/503,029

(22) PCT Filed: Aug. 13, 2014
(86) PCT No.: PCT/US2014/050868

§ 371 Date: Feb. 10, 2017

(51) Int. Cl. C03B 37/027; C03B 23/207; C03B 37/012

(52) U.S. Cl. CPC C03B 37/02736; C03B 37/01205; C03B 23/207

(57) ABSTRACT

A method of producing a quartz glass optical component is provided. The method includes providing a cylindrical quartz glass body made of core rod glass and cladding glass. The quartz glass body has a square cut first end having a first outer diameter. The method further includes providing a glass handle having a first end and an opposing square cut second end having a second outer diameter which is between 50% and 110% of the first outer diameter; attaching the square cut end of the glass handle to that of the quartz glass body; and using the glass handle to guide the quartz glass body through a draw furnace. A distortion in a clad-to-core ratio proximate the interface of the cylindrical quartz glass body and the glass handle is less than 5%.

### TECHNICAL FIELD

The invention relates to a system and method for producing an optical component of quartz glass, particularly for waveguide or optical fiber applications, while reducing waveguide distortions and ensuring uniform temperature and viscosity distribution throughout the quartz glass in its thermal processes. Such thermal processes include, but are not limited to, preform or fiber drawing, stretching, compressing, collapsing, or overcladding.

### BACKGROUND

Examples of quartz glass optical component include, for example, a solid or hollow cylinder, a preform for optical fibers, or an optical fiber. Such optical components are typically formed using a coaxial arrangement of a quartz glass core rod inserted within the bore of a quartz glass overclad cylinder. Starting with its lower end, the coaxial arrangement is supplied to the heating zone of a vertically-oriented draw furnace, in which it is heated zonewise and elongated into the solid or hollow cylinder, optical fiber preform or optical fiber. Alternatively, the starting body may be an optical fiber preform, which is then drawn into a plurality of smaller-sized preforms or an optical fiber.

Such draw methods typically require a glass handle to be attached to the upper end of the coaxial arrangement or preform in order to guide the arrangement or preform through the draw furnace. Various measures have been taken in connection with the glass handle in conventional drawing processes in order to reduce costs. For example, the glass handle is normally in the form of a solid or hollow cylinder having a smaller outer diameter than that of the quartz glass body to be drawn (i.e., the coaxial arrangement or optical fiber preform). Also, the type of glass used to form the glass handle may be of inferior quality to that of the quartz glass body to be drawn. That is, the glass used to make the glass handle typically is not used to form part of the final waveguide or optical fiber product, and can therefore be made of a cheaper material that contains more impurities and/or contaminants and has different thermal properties than the glass of the coaxial arrangement or optical fiber preform.

However, such cost-saving measures have drawbacks. In particular, when the glass handle is welded to the coaxial arrangement or optical fiber preform and the welded arrangement is then drawn, the glass at the handle end of the arrangement/preform cannot be drawn into acceptable optical fiber. Specifically, the optical fiber drawn from the glass proximate the handle typically has poor waveguide properties, such as an incorrect or distorted clad-to-core ratio, that could result in unacceptable cutoff wavelength, modefield diameter, zero dispersion wavelength, increased core eccentricity due to a radial misalignment between the core and the cladding glasses, a non-uniform outer diameter or geometry, and the like, in the drawn fiber.

Control problems are also often encountered with conventional drawing systems and methods, in that one must determine when exactly to terminate the draw to avoid drawing the distorted or “bad” end glass. The so-called “end effects” occur within a certain length of the coaxial arrangement/optical fiber preform proximate the glass handle. This length is often comparable to the length of the heat zone of the draw furnace (e.g., typically 10 to 20 cm) and typically similar to the diameter of the glass component being drawn due to the desirable efficiency of radiative heat exchange or transfer between the glass component and the draw furnace. Thus, the draw is typically terminated once this length is reached, before all of the glass of the coaxial arrangement/optical fiber preform has been drawn. The undrawn glass at the end of the coaxial arrangement/optical fiber preform attached to the handle must be discarded and the amount of wasted glass typically increases with the diameter of the glass component being drawn.

Accordingly, it would be beneficial to provide improved methods which allow for drawing of the entire quartz glass coaxial arrangement or optical preform when forming optical components, in order to avoid wasting valuable quartz glass.

### SUMMARY

The invention is based on our discovery of the root cause of the above-described end effects, which was unknown until now. Specifically, we have found that these end effects are the result of the glass at the trailing end of the coaxial arrangement/optical fiber preform (i.e., the end attached to the handle) becoming distorted during the drawing process. We have further discovered that these distortions occur in the end glass primarily because the heated inner and central portion of the glass that contains the fiber core flows axially downwardly (e.g., by gravity or externally applied drawing or holding forces) at a different rate than the heated outer cladding glass due to radially non-uniform temperature and viscosity distribution within the glass body. More particularly, we have found that, as the handle end of the coaxial arrangement/optical fiber preform approaches the heating zone of the draw furnace, the outer cladding glass is heated to a higher temperature than the inner core glass, and thus the relatively hotter outer cladding glass flows axially downwardly faster than the inner core glass. As a result, the outer cladding glass droops or slumps down further than the inner core glass, thereby distorting the glass clad-to-core ratio at the handle end and destroying the waveguide properties of the optical component drawn therefrom. In addition, such differential axial flow of glass near the handle end is frequently azimuthally asymmetric (e.g., due to the azimuthally asymmetric temperature distribution experienced by the glass body within the draw furnace) which, in turn, can cause a significant increase in the fiber core eccentricity.

We have further found that the differential axial flow of the core and cladding glasses occurs primarily because the handle and the attached trailing end of the coaxial arrangement/optical fiber preform typically have different outer diameters, thereby resulting in a radial geometric discontinuity at the handle end. This radial discontinuity, in turn, causes a radiative heat load to be generated proximate the interface of the glass handle and the coaxial arrangement/optical fiber preform and a radially non-uniform temperature and viscosity distribution for the core and cladding glasses proximate the interface.

We have also found that other factors, such as differences in the geometric shape and thermal properties of the glass handle and coaxial arrangement/optical fiber preform, can cause radially non-uniform temperature and viscosity distribution of the end glass. The non-uniform temperature distribution causes the core and cladding glasses to flow downwardly at different rates, thereby distorting and destroying the necessary relative proportions of the core and cladding glasses (commonly referred to as the clad-to-core ratio) for useful waveguide or optical fiber applications.

One embodiment of the invention is directed to a method of producing a quartz glass optical component. The method comprises: providing a cylindrical quartz glass body comprised of core rod glass and cladding glass surrounding the core rod glass, the cylindrical quartz glass body having a square cut first end having a first outer diameter, an opposing second end, and a longitudinal axis extending between the opposing first and second ends; providing a glass handle having a first end and an opposing square cut second end having a second outer diameter, the second outer diameter being within 50% and 110% of the first outer diameter; attaching the square cut second end of the glass handle to the square cut first end of the quartz glass body to define an interface; and using the glass handle to guide the quartz glass body through a draw furnace to heat the core glass and the cladding glass of the quartz glass body to produce a quartz glass optical component, wherein a distortion in a clad-to-core ratio proximate the interface is less than 5%.

Another embodiment of the invention relates to a method of forming optical fiber preforms. The method comprises: passing a quartz glass body through a furnace having a heating zone, the quartz glass body having a first end and an opposing second end; forming at least one neck-down region between the first and second ends of the quartz glass body in the heating zone; and cutting the quartz glass body at a narrowest portion of the at least one neck-down region to form a first optical fiber preform and a second optical fiber preform. Each of the first and second optical fiber preforms has a tapered square cut first end and an opposing second end.

Another embodiment of the invention relates to a system for producing a quartz glass optical component. The system comprises: a quartz glass body comprised of core rod glass and cladding glass surrounding the core rod glass, the quartz glass body having a square cut first end having a first outer diameter, an opposing second end, and a longitudinal axis extending between the opposing first and second ends; and a glass handle having a first end and an opposing square cut second end having a second outer diameter. The square cut second end of the glass handle is attached to the square cut first end of the quartz glass body to define an interface where the second outer diameter is between 50% and 110% of the first outer diameter, such that when the core glass and the cladding glass proximate the interface are heated to produce a quartz glass optical component, a distortion in a clad-to-core ratio proximate the interface is less than 5%.

### BRIEF DESCRIPTION OF DRAWINGS

The foregoing summary, as well as the following detailed description of preferred embodiments of the invention, will be better understood when read in conjunction with the appended drawings. For the purpose of illustration, there are shown in the drawings embodiments which are preferred. It should be understood, however, that the device and method are not limited to the precise arrangements and instrumentalities shown. In the drawings:

FIG. 1 is a partial cross-sectional view of a system for producing an optical component in accordance with one embodiment of the invention;

FIG. 2A is a perspective side view of a quartz glass body used to produce an optical component in accordance with an embodiment of the invention;

FIG. 2B is a cross-sectional view of the quartz glass body shown in FIG. 2A;

FIG. 3A is a perspective side view of a glass handle used to produce an optical component in accordance with an embodiment of the invention;

FIG. 3B is a cross-sectional view of the glass handle shown in FIG. 3A;

FIG. 4 is a partial cross-sectional view of a system for producing a quartz glass body which may be drawn into an optical component in accordance with an embodiment of the invention;

FIG. 5 is a cross-sectional view of a system for producing a quartz glass body which may be drawn into an optical component in accordance with another embodiment of the invention; and

FIG. 6 is a cross-sectional view of the quartz glass body produced by the systems of FIGS. 4-5.

### DETAILED DESCRIPTION

The invention relates to a system and method for producing optical fiber performs or optical fibers. It will be understood by those skilled in the art that the preforms produced from the below described system and methods may be utilized for various other purposes than for fabricating an optical fiber preform or optical fiber. More particularly, the invention relates to a method for drawing an optical fiber preform or an optical fiber while reducing or preventing waveguide distortions in the glass during the drawing process. The invention also results in improved core eccentricity and uniformity of cladding diameter in an optical fiber to be drawn from the preform.

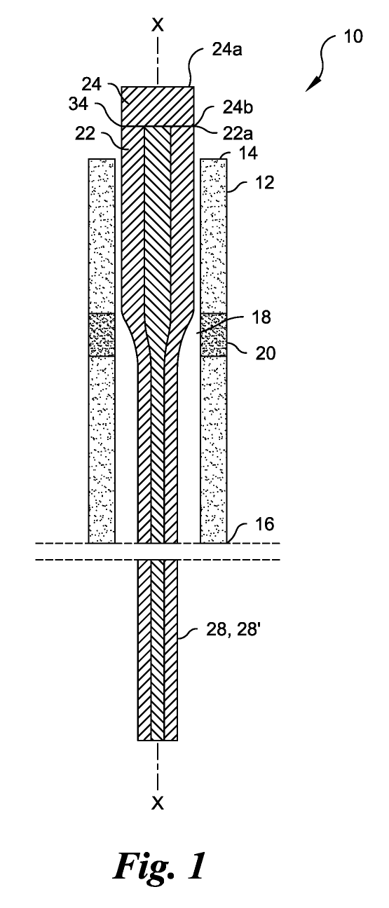

Referring to FIG. 1, there is shown a system 10 for producing an optical fiber perform or an optical fiber. The system 10 includes a vertically arranged drawing tower 12 comprising an upper open end 14, an opposing lower open end 16, and a heating zone 18 between the upper and lower ends 14, 16. The heating zone 18 can preferably be heated to temperatures of 500° C. to 2,300° C., and more preferably 1,000° C. to 2,300° C., and most preferably 1,500° C. to 2,300° C., by a heating element 20 (see FIG. 1). More particularly, the heating element 20 is preferably of an annular configuration. The heating element 20 is preferably positioned within or around the drawing tower 12 so as to form the heating zone 18 of the drawing tower 12.

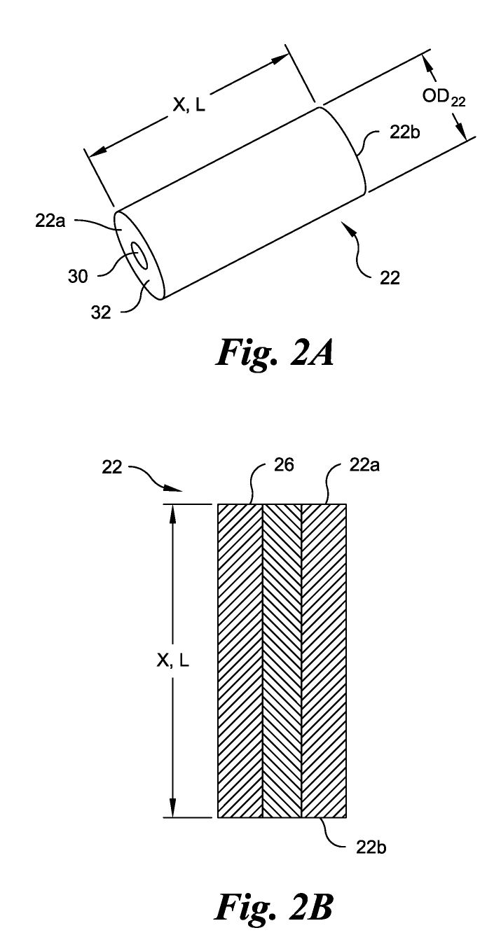

A quartz glass body 22 is guided through the drawing tower 12 by a glass handle 24 to produce optical fiber preforms or optical fibers. Referring to FIGS. 2A-2B, the glass body 22 is of a cylindrical or tubular configuration. The glass body 22 has a length L which extends from a first or upper end 22a to an opposing second or lower end 22b. A longitudinal axis X extends between the opposing first and second ends 22a, 22b. The first end 22a is preferably a square cut end. That is, the first end 22a is blunt and planar, such that the face 26 of the first end 22a extends perpendicularly to the longitudinal axis X of the glass body 22. More particularly, the end face 26 preferably extends within ±5° of 90° with respect to the longitudinal axis X of the glass body 22. More preferably, both the first and second ends 22a, 22b of the glass body 22 are square cut ends.

The quartz glass body 22 is preferably comprised of a core or core rod glass 30 containing the waveguiding optical fiber core and cladding glass 32 surrounding the core rod glass 30. More particularly, the core rod glass 30 is preferably formed in the geometric center of the quartz glass body 22 and extends along the length L thereof. The cladding glass 32 is preferably formed over the core rod glass 30 to radially surround the core rod glass 30 along the length L of the quartz glass body 22.

The cladding glass 32 may be pure quartz glass or a doped quartz glass with a different refractive index or composition. Preferably, however, the cladding glass 32 is pure quartz glass. The core rod glass 30 is preferably a mostly pure quartz glass having a simple step or a complex radial refractive index profile at or near the waveguiding core.

Referring to FIG. 1, the glass body 22 is passed through the drawing tower 12, where it is heated, softened and elongated to form an optical component, such as an optical fiber preform 28 or an optical fiber 28′. More particularly, the lower end 22b of the glass body 22 is preferably positioned in a stable manner at the upper open end 22 of the drawing tower 12 at the start of the draw and the glass body 22 then progresses in a downward direction through the drawing tower 12. In the drawing tower 12, the glass body 22 is heated in a zone-wise manner in the heating zone 18. A preform 28 or fiber 28′ is continuously drawn out from the lower open end 16 by melt deformation and optionally stretching/elongation by gravitational or externally applied pulling or compressing forces during the draw.

For purposes of the production method, and more particularly for purposes of the progression of the glass body 22 through the drawing tower 12, the lower end 22b of the body 22 is a leading end and the upper end 22a is a trailing end. Also, it will be understood by those skilled in the art that any conventional vertically-oriented drawing apparatus may be used for formation of the optical fiber preform or the optical fiber, provided that the apparatus is equipped with a heating element.

In one embodiment, the glass body 22 is a coaxial assembly of two separate glass components. More particularly, the core rod glass 30 is in the form of a solid and cylindrical core rod and the cladding glass 32 is in the form of a hollow overclad cylinder surrounding the core rod 30 (i.e., a rod-in-cylinder assembly). In the coaxial assembly, the core rod 30 and the overclad cylinder 32 are not fused together before the furnace draw.

In one embodiment, at least one jacket (not shown) is provided in the gap between the core rod glass 30 and the cladding glass 32. The jacket is preferably made of a fluorine-doped glass, and more preferably a fluorine-doped quartz glass. However, it will be understood that the jacket need not be made of quartz glass and may of a different composition glass.

As the coaxial assembly of this embodiment of the glass body 22 progresses from the upper open end 14 of the drawing tower 12 toward the lower open end 16, the core rod 30 and the overclad cylinder 32 are heated to a predetermined temperature sufficient to cause the two glass components to soften and fuse together to form a monolithic glass body. More particularly, as successive portions of the two-piece glass body 22 approach the heating zone 18 and are heated therein, the overclad glass cylinder 32 and the core rod 30 become softened and the softened overclad glass cylinder 32 collapses on and fuses with the core rod 30. At least one, and more preferably a plurality of preforms 28, or an optical fiber 28′ may then be drawn from the resulting monolithic glass body.

Preferably, the coaxial arrangement of this embodiment of the glass body 22 is heated to temperatures of 500° C. to 2,300° C., and more preferably 1,000° C. to 2,300° C., and most preferably 1,500° C.-2,300° C. More preferably, softening and collapsing of the overclad cylinder 32 on the core rod 30 occurs at a temperature of 1,000° C. to 2,200° C., and more preferably 1,300° C. to 2,000° C., and most preferably 1,600° C.-1,800° C. Fusing together of the softened and collapsed overclad cylinder 32 with the softened core rod 30 preferably occurs at a temperature of 1,000° C. to 2,200° C., and more preferably 1,300° C. to 2,200° C., and most preferably 1,600° C.-2,200° C. However, it will be understood by those skilled in the art that other factors, such as glass material composition, draw speed, and throughput, also affect the temperature at which the overclad cylinder 32 will collapse on and fuse with the core rod 30.

In another embodiment, the glass body 22 is in the form of a one-piece monolithic solid quartz glass cylinder, and more preferably in the form of an optical fiber preform. That is, in one embodiment, the core rod glass 30 and the cladding glass 32 have already been fused together and drawn into a monolithic optical fiber preform. The optical fiber preform of this embodiment of the glass body 22 may be a mother preform of a relatively large diameter which is passed through the drawing tower 12 to produce a plurality of smaller-sized preforms 28. Alternatively, the optical fiber preform of this embodiment of the glass body 22 may be dimensioned to be directly drawn into an optical fiber 28′.

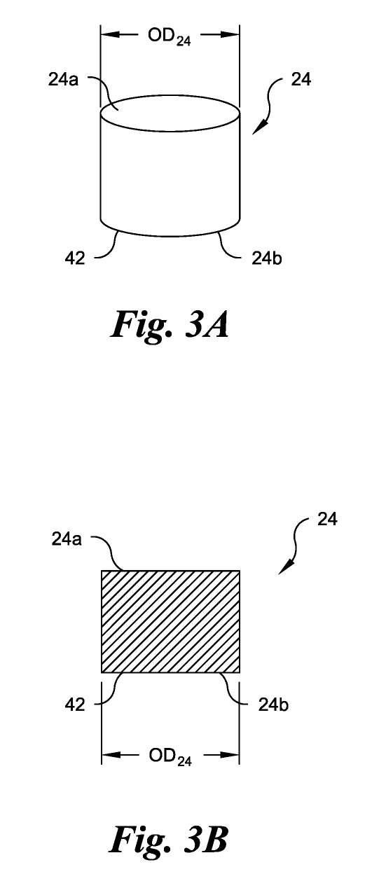

Referring to FIGS. 1 and 3A-3B, the glass handle 24 is preferably utilized to guide the glass body 22 through the drawing tower 12. Specifically, the glass handle 24 has a first trailing end 24a and an opposing second leading end 24b. The second end 24b is preferably a square cut end. More preferably, both the first and second ends 24a, 24b of the glass handle 24 are square cut ends. The square cut second end 24b of the glass handle 24 is preferably secured to the square cut first or upper end 22a of the glass body 22. More preferably, the square cut second end 24b of the glass handle 24 is welded to at least the cladding glass 32 of the first end 22a of the glass body 22. Alternatively, the square cut second end 24b of the glass handle 24 may be welded to the entire face 26 of the glass body 22 at the first end 22a. Since the welded ends 22a and 24b are each square cut, the respective end faces 26, 42 rest flush against each other at an interface 34.

It will be understood by those skilled in the art that while the term handle is used hereinafter for illustrative purposes, any appropriate descriptive term, such as lid, cover plug, collar, endcap, and the like, may be utilized for purposes of identifying the handle-like component.

In one embodiment, the glass handle 24 is preferably in the form of a solid or hollow cylinder having a uniform outer diameter OD₂₄ extending along a length thereof. The cylindrical glass body 22 also preferably has a uniform diameter OD₂₂ along its entire length L.

In one embodiment, as shown in FIGS. 3A-3B, the outer diameter OD₂₄ of the glass handle 24 is preferably between 50% and 110%, and more preferably between 60% and 110%, of the outer diameter OD₂₂ of the glass body 22. More particularly, the outer diameter OD₂₄ of the square cut second end 24b of the glass handle 24 is between 50% and 110%, and more preferably between 60% and 110%, of the outer diameter OD₂₂ of the square cut first end 22a of the glass body 22. More preferably, the outer diameter OD₂₄ of the square cut second end 24b of the glass handle 24 is equal to the outer diameter OD₂₂ of the square cut first end 22a of the glass body 22.

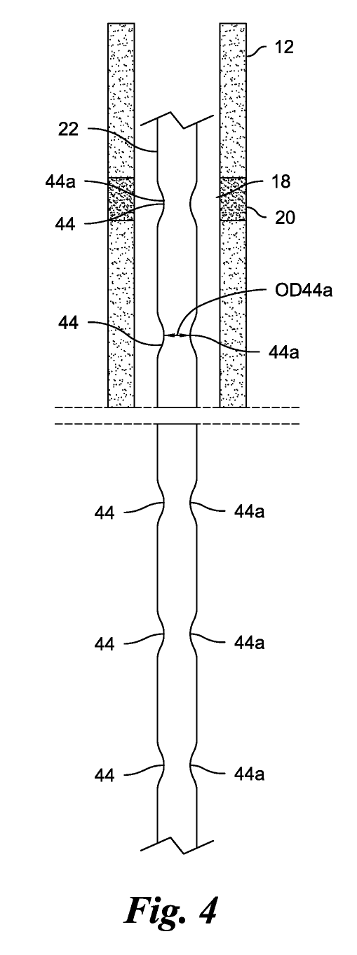

In another embodiment, the outer diameter OD₂₄ of the glass handle 24 is smaller than the initial outer diameter OD₂₂ of the glass body 22. In such an embodiment, the square cut first end 22a of the glass body 22 (i.e., the end to which the glass handle 24 is attached) is preferably tapered to better match the outer diameter OD₂₄ of the glass handle 24, thereby forming a tapered glass body 22′ (see FIGS. 4-6). The outer diameter OD_{22a′} of the tapered square cut end 22a′ is thus smaller than the outer diameter OD_{22′} of the second end 22b′. More particularly, as shown in FIG. 6, in the tapered glass body 22′, the square cut first end 22a′ is preferably tapered, such that the outer diameter OD₂₄ of the glass handle 24 is preferably between 50% of the outer diameter OD_{22a′} of the tapered square cut end 22a′ and 110% of the outer diameter OD_{22a′} of the second end 22b′ of the glass body 22′. More preferably, the outer diameter OD₂₄ of the glass handle 24 is preferably between 60% of the outer diameter OD_{22a′} of the tapered square cut end 22a′ and 110% of the outer diameter OD_{22′} of the second end 22b′ of the glass body 22′. Most preferably, the outer diameter OD₂₄ of the glass handle 24 is equal to the outer diameter OD_{22a′} of the tapered square cut end 22a′. Preferably, the square cut first end 22a′ of the glass body 22′ is configured as a conical taper, although it will be understood that any tapered configuration may be acceptable.

Such a tapered glass body 22′ may be formed by any known methods or new methods yet to be developed, as long as the method preserves the clad-to-core ratio of the waveguide. For example, the tapered square cut end 22a′ may be formed by applying a heat source to the first end 22a′ until the end 22a′ is tapered to the outer diameter OD_{22a′}. Examples of such heat sources include, but are not limited to, an oxyhydrogen torch, a propane torch, a plasma torch and the like.

In one embodiment, as shown in FIG. 4, the tapered glass body 22′ is formed by passing a glass body 22 through the drawing furnace 12 and heating spaced-apart portions of the body 22 while simultaneously stretching or elongating the body 22. As a result, spaced-apart neck-down or tapered regions 44, each having an hourglass-like shape having two opposing conical tapered sections, are formed along the length L of the glass body 22. The outer diameter OD₄₄ₐ of the narrowest portion 44a of each neck-down region 44 is generally equal to the outer diameter OD₂₄ of the relatively smaller handle 24. The glass body 22 may then be cut at the narrowest portion 44a of each neck-down region 44, thereby forming a plurality of tapered glass bodies 22′, each having a square cut first end 22a′ having an outer diameter OD_{22a′}.

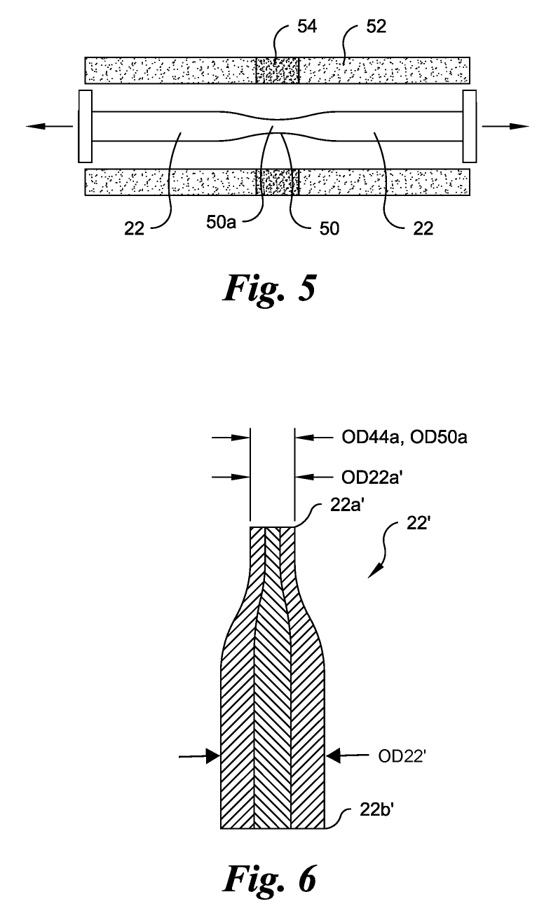

As another example, shown in FIG. 5, the tapered glass body 22′ may be formed by welding two glass bodies 22 together and then pulling the attached bodies 22 away from each other (i.e., stretching the attached bodies 22) while simultaneously heating at least one portion thereof in a furnace 52 having a heater 54. As a result, an intermediate neck-down or tapered region 50, of a similar geometry to the neck-down region 44 described above, is formed. The attached glass bodies 22 may then be cut at the narrowest portion 50a of the neck-down region 50, thereby forming a pair of tapered glass bodies 22′, each having a square cut first end 22a′ having an outer diameter OD_{22a′} that is generally equal to the outer diameter OD₂₄ of the square cut second end 24b of the glass handle 24. It will be understood that multiple spaced-apart portions of the attached bodies 22 may be heated to form a plurality of spaced-apart neck-down regions 50 and a plurality of tapered glass bodies 22′.

The two different types of glass bodies 22, 22′ will be described herein collectively by reference solely to “the glass body 22.” As such, it will be understood that the below description applies to both the glass body 22 of a uniform diameter OD₂₂ and the glass body 22′ having a tapered end 22a′.

Due to the generally equal outer diameters OD₂₂ₐ and OD_{24b} of the attached square cut ends 22a, 24b, the interface 34 of the handle 24 and the glass body 22 has a generally uniform radial geometry. More particularly, the handle/body interface 34 has a uniform outer diameter with no radial discontinuity, such that as the glass handle 24 guides the glass body 22 through the draw tower 12, there is minimal thermal perturbation that arises from the scattering and absorption of non-uniform radiative heat proximate to or at the interface 34, such that there is uniform radial temperature and viscosity distribution at or proximate to the interface 34. Preferably, the non-uniform radiative heat load generated proximate the interface 34 results in a radial temperature difference of less than 200° C. , and more preferably less than 100° C., and most preferably less than 50° C.

Consequently, there is a uniform radial temperature distribution proximate the interface 34, such that the core rod glass 30 and the cladding glass 32 proximate the draw handle end (i.e., the interface 34) are heated up to the same temperature at the same rate, and the heated glasses 30, 32 have generally equal viscosities and therefore generally equal axial flow rates. That is, the heated core rod glass 30 and the heated cladding glass 32 proximate the handle/body interface 34 flow in a downward direction along the longitudinal axis L₂₂ at generally equal rates, such that the glass proximate the interface 34 does not become distorted. As a result, the core rod and the cladding glasses 30, 32 remain radially aligned relative to each other, the outer cladding glass 32 has uniform outer diameter or geometry, and the cladding-to-core ratio necessary for the final waveguide or optical fiber product is maintained. More particularly, a distortion of the clad-to-core ratio proximate the interface 34 is preferably less than 5%, and more preferably less than 3%, and most preferably less than 1%.

It will be understood that there may be a slight deviation between the outer diameters OD₂₂ₐ and OD_{24b} of the attached square cut ends 22a, 24b, as long as the radial temperature difference proximate the interface 34 is less than 200° C., and more preferably less than 100° C., and most preferably less than 50° C., such that there is a radially uniform temperature and viscosity distribution proximate the interface 34. It will be understood that there may be a slight deviation between the axial flow rates of the heated core rod and cladding glasses 30, 32 proximate the draw handle end (i.e., the interface 34), as long as any radial non-uniformity in the temperature distribution in the glass proximate the interface 34 is limited as discussed above. More particularly, the axial flow rates may deviate slightly from each other, as long as any change or distortion of the clad-to-core ratio proximate the interface 34 is less than 5%, more preferably less than 3%, and most preferably less than 1% for optimal waveguide or optical fiber performance.

In one embodiment, the glass handle 24 is made of the same type of glass as the cladding glass 32 of the glass body 22. In one embodiment, the glass handle 24 is an optical fiber perform having the same types of core rod and cladding glasses as the core rod and cladding glasses 30, 32 of the glass body 22.

In one embodiment, the glass handle 24 is an undrawn (i.e., new or fresh) optical fiber preform and the glass body 22 is a remnant of an already drawn preform (i.e., a preform stub). More particularly, the preform stub (i.e., the glass body 22) may be formed by drawing a portion of an optical fiber preform and leaving a tapered or tipped portion of the preform undrawn which can facilitate the start of subsequent fiber draw when welded to an undrawn square cut preform (i.e., the glass handle 24). The tapered or tipped remnant portion of a drawn preform is an optical fiber preform stub, which may then serve as the glass body 22 to be welded to the square cut second end 24b of a fresh or new preform which serves as the handle 24.

In another embodiment, the glass handle 24 is a scrap preform which is a preform whose waveguide performance or optical fiber properties have been shown (in previous tests of “sister” material) to be insufficient to result in acceptable waveguide or optical fiber products.

In another embodiment, the glass handle 24 is made of a different type of glass than the glass body 22, and more preferably the glass handle 24 is made of an inferior quality glass of lower cost (e.g., a natural quartz glass having more impurities, contaminants and the like than the higher cost synthetic silica glass body 22 typically used for waveguide or optical fiber products).

In such an embodiment, even though the glass handle 24 and the glass body 22 have differing compositions, minimal to no distortions occur in the glass at the body/handle interface 34 occur because of the uniform radial geometry of the interface 34. That is, even though the different glasses of the handle 24 and body 22 have differing viscosities, thermal conductivities, heat transfer coefficients and the like, there is still no or only a minimal thermal perturbation proximate the interface 34 because the outer diameter OD₂₄ of the glass handle 24 is preferably between 50% and 110% of the outer diameter OD₂₂ of the glass body 22. As such, a radially uniform temperature distribution is maintained and the core rod glass 30 and the cladding glass 32 proximate the interface 34 have a radially uniform axial flow. In turn, the glass body 22 may be drawn up to the interface 34 to form acceptable waveguides or optical fibers products. That is, the end of the resulting waveguides or optical fibers products (i.e., the portion drawn from the end 22a of the glass body 22 attached to the handle 24) has a clad-to-core ratio, mode field diameter, core eccentricity, geometric proportions and symmetries, cutoff wavelength, zero dispersion wavelength and the like which all fall within the required tolerances for optical waveguides or fiber components.

The invention allows for increased yield from an optical component draw. The optical component draw yield is preferably between 80 to 100%, and more preferably 90 to 100%, and most preferably more than 95%. Also, as compared to conventional drawing processes, the downgrade and scrap rates are significantly reduced. The downgrade rate is preferably between 0 to 20%, and more preferably 0 to 10%, and most preferably less than 5%. The scrap rate is preferably between 0 to 10%, and more preferably 0 to 5%, and most preferably less than 1%.

The invention will now be described with reference to the following example.

### EXAMPLE 1

A first cylinder assembly and a second cylinder assembly were welded together.

The first and second cylinder assemblies were identical to each other. Each assembly was formed by a core rod inserted within an overclad cylinder made of dry (<1 ppm OH) synthetic silica. Each assembly had a 200 mm outer diameter and a 43-46 mm inner diameter. The ends which were welded together were square cut ends. The welded cylinder/core-rod assembly was drawn at temperature up to 2200° C. The resulting optical preforms and fibers proximate the cylinder weld region (i.e., the interface between the first and second cylinder assemblies) had less than a 1% deviation from the design clad-to-core ratio of 3.2, as well as a less than 1% deviation from the target cutoff wavelength. Such results are indicative of a radial uniformity of better than 1% for the relative axial glass flows.

### EXAMPLE 2

A glass handle in the form of a natural quartz collar having an outer diameter of 200 mm and an inner diameter of 126 mm was welded to the top of a 200 mm outer diameter and 46 mm inner diameter cylinder assembly. The cylinder assembly was formed by a core rods inserted within a dry (<1 ppm OH) synthetic silica overclad cylinder. The welded ends were both square cut ends. The glass handle was then utilized to pass the cylinder assembly through a furnace to draw optical fiber preforms at a temperature up to 2200° C. The final optical fiber preforms, which included glass proximate the interface between the glass handle and the cylinder assembly, exhibited less than a 1% deviation from the design clad-to-core ratio of 3.2 and no fiber core eccentricity failures. Such results are indicative of a radial uniformity of better than 1% for the relative axial glass flows.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the invention as defined by the appended claims.

We claim:

1. A method of producing a quartz glass optical component, the method comprising:
providing a cylindrical quartz glass body comprised of core rod glass and cladding glass surrounding the core rod glass, the cylindrical quartz glass body having a square cut first end having a first outer diameter, an opposing second end, and a longitudinal axis extending between the opposing first and second ends;
providing a glass handle having a first end and an opposing square cut second end having a second outer diameter, the second outer diameter being between 50% and 110% of the first outer diameter;
attaching the square cut second end of the glass handle to the square cut first end of the quartz glass body to define an interface; and
using the glass handle to guide the quartz glass body through a draw furnace to heat the core rod glass and the cladding glass of the quartz glass body to produce a quartz glass optical component, wherein a distortion in a clad-to-core ratio proximate the interface is less than 5%.

2. The method according to claim 1, wherein a composition of the glass handle is the same as a composition of the cylindrical quartz glass body.

3. The method according to claim 1, wherein a composition of the glass handle is different from a composition of the quartz glass body.

4. The method according to claim 1, wherein the glass handle is in the form of a solid rod or a hollow cylinder.

5. The method according to claim 1, wherein the glass handle is an optical fiber preform having a square cut end and the cylindrical quartz glass body is a remnant of an already drawn optical fiber preform.

6. The method according to claim 1, wherein the glass handle is in the form of a scrap optical fiber preform.

7. The method according to claim 1, wherein the cylindrical quartz glass body is an optical fiber preform.

8. The method according to claim 1, wherein the cylindrical quartz glass body is a coaxial assembly of a core rod surrounded by an overclad cylinder, the core rod and the overclad cylinder remaining separate from each other prior to being heated in the draw furnace.

9. The method according to claim 8, wherein the glass handle is a coaxial assembly of a core rod surrounded by an overclad cylinder, the core rod and the overclad cylinder remaining separate from each other prior to being heated in the draw furnace.

10. The method according to claim 9, wherein the core rod glass and the cladding glass of the cylindrical quartz glass body and the glass handle are softened in the draw furnace, and the softened cladding glass collapses on and fuses with the softened core rod glass to form an optical fiber preform.

11. The method according to claim 1, wherein the square cut second end of the glass handle is welded to the square cut first end of the cylindrical quartz glass body.

12. The method according to claim 11, wherein the welding is performed using a process selected from the group consisting of hydrogen welding, propane welding, arc welding, plasma welding, and laser welding.

13. The method according to claim 1, wherein an outer diameter of the second end of the cylindrical quartz glass body is larger than the first outer diameter of the square cut first end, the method further comprising applying a heat source to the first end of the cylindrical quartz glass body to form a tapered and square cut end, the second outer diameter of the glass handle being between 50% of an outer diameter of the tapered end and 110% of the first outer diameter.

14. A method of forming optical fiber preforms, the method comprising:
passing a quartz glass body through a furnace having a heating zone, the quartz glass body having a first end and an opposing second end;
forming at least one neck-down region between the first and second ends of the quartz glass body in the heating zone; and
cutting the quartz glass body at a narrowest portion of the at least one neck-down region to form a first optical fiber preform and a second optical fiber preform, each of the first and second optical fiber preforms having a tapered square cut first end and an opposing second end.

15. The method according to claim 14, wherein a plurality of spaced-apart neck-down regions are formed between the first and second ends of the quartz glass body.

16. The method according to claim 14, wherein the square cut first end of each optical fiber preform is configured as a conical taper.

17. A method of drawing optical fibers, the method comprising:
forming a first optical fiber preform according to the method of claim 14, the first optical fiber preform comprising core rod glass and cladding glass surrounding the core rod glass;
attaching a square cut end of a glass handle to the tapered square cut first end of the first optical fiber preform to define an interface, an outer diameter of the square cut end of the glass handle being between 50% of an outer diameter of the tapered square cut first end of the first optical fiber preform and 110% of an outer diameter of the second end of the optical fiber preform;
using the glass handle to guide the first optical fiber preform in a downward direction through a vertically-oriented draw furnace to heat the core rod glass and the cladding glass and draw an optical fiber, wherein a distortion in a clad-to-core ratio proximate the interface is less than 5%.

18. The method according to claim 17, wherein the square cut end of the glass handle is welded to the tapered square cut first end of the first optical fiber preform.

19. A system for producing a quartz glass optical component, the system comprising:
a quartz glass body comprised of core rod glass and cladding glass surrounding the core rod glass, the quartz glass body having a square cut first end having a first outer diameter, an opposing second end, and a longitudinal axis extending between the opposing first and second ends; and
a glass handle having a first end and an opposing square cut second end having a second outer diameter,
wherein the square cut second end of the glass handle is attached to the square cut first end of the quartz glass body to define an interface where the second outer diameter is between 50% and 110% of the first outer diameter, such that when the core glass and the cladding glass proximate the interface are heated to produce a quartz glass optical component, a distortion in a clad-to-core ratio proximate the interface is less than 5%.
